(19) United States
(12) Patent Application Publication
(10) Pub. No.: US 2023/0318702 A1
(43) Pub. Date: Oct. 5, 2023

(54) FAILURE DETECTION APPARATUS, CABLE BRANCHING DEVICE, AND TRANSMISSION PATH SURVEILLANCE METHOD

(71) Applicant: NEC Corporation, Minato-ku, Tokyo (JP)

(72) Inventor: Taiki Kanai, Tokyo (JP)

(73) Assignee: NEC Corporation, Minato-ku, Tokyo (JP)

(21) Appl. No.: 18/024,852

(22) PCT Filed: Sep. 7, 2021
(86) PCT No.: PCT/JP2021/032774

§ 371 Date: Mar. 6, 2023

(30) Foreign Application Priority Data
Sep. 14, 2020 (JP) 2020-153411

(51) Int. Cl. H04B 10/077; H04B 10/032

(52) U.S. Cl. CPC H04B 10/077; H04B 10/032

(57) ABSTRACT

A failure detection apparatus for submarine optical cables having a redundant configuration, the apparatus comprising, with a view to detecting a failure in an active transmission path and a standby transmission path: a first optical coupler which branches and outputs a supervisory signal to the active transmission path and the standby transmission path; a second switch functional unit which outputs the supervisory signal outputted from either the active transmission path or the standby transmission path that is specified as a test transmission path; and a transmission path monitoring unit which, on the basis of the supervisory signal received from the second switch functional unit, detects a failure taking place in said test transmission path.

### TECHNICAL FIELD

The present invention relates to a technique for detecting a failure in an optical submarine cable system.

### BACKGROUND ART

One example of a technique for detecting a failure in an optical submarine cable system is disclosed in PTL 1. In an optical submarine transmission system in PTL 1, a main line cable and a standby line cable are laid on a land section by different routes. A land terminal station includes a breakage detection means for detecting breakage of the main line cable and a route switching means for switching a transmission route on the land section to the standby line cable. The breakage detection means detects breakage of a cable, based on a light reception level of a main signal that is sent from a cable on a submarine section, or based on a light reception level of a supervisory signal that is output from the breakage detection means and is reflected and returned from a beach manhole. The beach manhole includes an optical coupler that performs coupling/branching of the main signal in the main line cable and the standby line cable, and a small passive component such as a fiber grating or an optical coupler for returning the supervisory signal to the breakage detection means. As a result of the above configuration, in the optical submarine transmission system in PTL 1, a failure of a line on the land section that has a redundant configuration between the beach manhole and the land terminal station is detected in the optical submarine transmission system.

Another example of a technique for detecting a failure in an optical submarine cable system is disclosed in PTL 2. In a wavelength multiplexing optical submarine cable network in PTL 2, an optical transmitter of a transmission-side terminal station device receives a modulated signal from a line monitoring device, superposes the received signal as a line supervisory signal on an optical signal, and outputs the superposed signal to a relay line. The line supervisory signal that is turned back via a return line of each optical repeater inserted in the relay line is split by an optical coupler, and is input to the line monitoring device. An optical selector selects a feedback signal from each pair of fibers. An array waveguide grating-type filter divides a wavelength multiplexing optical signal of the selected pair of fibers into wavelengths λ1 to λn, and a selector selects a signal of the wavelength one by one. A photoreception unit performs photoelectric conversion, and a demodulation unit demodulates the fed-back line supervisory signal. A correlation unit checks whether the line supervisory signal is abnormal, and monitors whether there is a failure occurring in the relay line. When monitoring a line of one pair of fibers is completed, monitoring a line of a next pair of fibers is started. As a result of the above configuration, in the wavelength multiplexing optical submarine cable network in PTL 2, a wavelength multiplexing optical submarine cable network line is monitored.

### CITATION LIST

### Patent Literature

[PTL 1] Japanese Unexamined Patent Application Publication No. 2007-173943
[PTL 2] Japanese Unexamined Patent Application Publication No. H9-289494

### SUMMARY OF INVENTION

### Technical Problem

In general, in an optical submarine cable system, it is important for maintenance and operation to detect a failure in a transmission path such as a submarine optical cable or a repeater. In particular, in an optical submarine cable system in which a submarine optical cable has a redundant configuration (route diversity), it is important to detect a failure (monitor normality) not only for an active transmission path through which a main signal is transmitted, but also for a standby transmission path that is substituted for the active transmission path when a failure occurs.

However, the techniques described in PTLs 1 and 2 have a problem that a redundant configuration of a submarine optical cable is not considered in detection of a failure in the submarine optical cable.

The present invention has been made in view of the above-described problem, and a main object of the present invention is to detect a failure in an active transmission path and a standby transmission path in an optical submarine cable system in which a submarine optical cable has a redundant configuration.

### Solution to Problem

In one aspect of the present invention, a failure detection apparatus includes: a first optical coupler that splits and outputs a supervisory signal to an active transmission path and a standby transmission path; a second switch functional unit that outputs the supervisory signal being output from a test transmission path that is specified one of the active transmission path and the standby transmission path; and a transmission path monitoring unit that detects a failure in the test transmission path, based on the supervisory signal received from the second switch functional unit.

In one aspect of the present invention, a cable branching device includes a second switch functional unit that outputs a supervisory signal being split and output to an active transmission path and a standby transmission path and being output from a test transmission path that is specified one of the active transmission path and the standby transmission path.

In one aspect of the present invention, a failure detection method includes detecting, based on a supervisory signal being split and output to an active transmission path and a standby transmission path and being output from a test transmission path that is specified one of the active transmission path and the standby transmission path, a failure in the test transmission path.

### Advantageous Effects of Invention

The present invention has an advantageous effect that a failure in an active transmission path and a standby transmission path is able to be detected in an optical submarine cable system in which a submarine optical cable has a redundant configuration.

### BRIEF DESCRIPTION OF DRAWINGS

FIG. 1 is a block diagram illustrating one example of a configuration according to a first example embodiment of the present invention.

FIG. 2 is a flowchart illustrating an operation according to the first example embodiment of the present invention.

FIG. 3 is a block diagram illustrating one example of a configuration according to a second example embodiment of the present invention.

FIG. 4 is a sequence diagram illustrating one example of an operation according to the second example embodiment of the present invention.

FIG. 5 is a block diagram illustrating one example of a configuration according to a third example embodiment of the present invention.

FIG. 6 is a sequence diagram illustrating one example of an operation according to the third example embodiment of the present invention.

FIG. 7 is a block diagram illustrating one example of a configuration according to a fourth example embodiment of the present invention.

### EXAMPLE EMBODIMENT

Hereinafter, example embodiments of the present invention will be explained in detail with reference to the drawings. Note that, a similar component is assigned with a similar reference sign throughout all the drawings, and explanation therefor will be omitted as appropriate.

### First Example Embodiment

A first example embodiment of the present invention, which is basic to a second example embodiment (to be described later) and a third example embodiment (to be described later) of the present invention and is based on a first example embodiment (to be described later) of the present invention, will be explained. In the present example embodiment, a first submarine terminal station device controls execution of a test for a transmission path.

A configuration according to the present example embodiment will be explained.

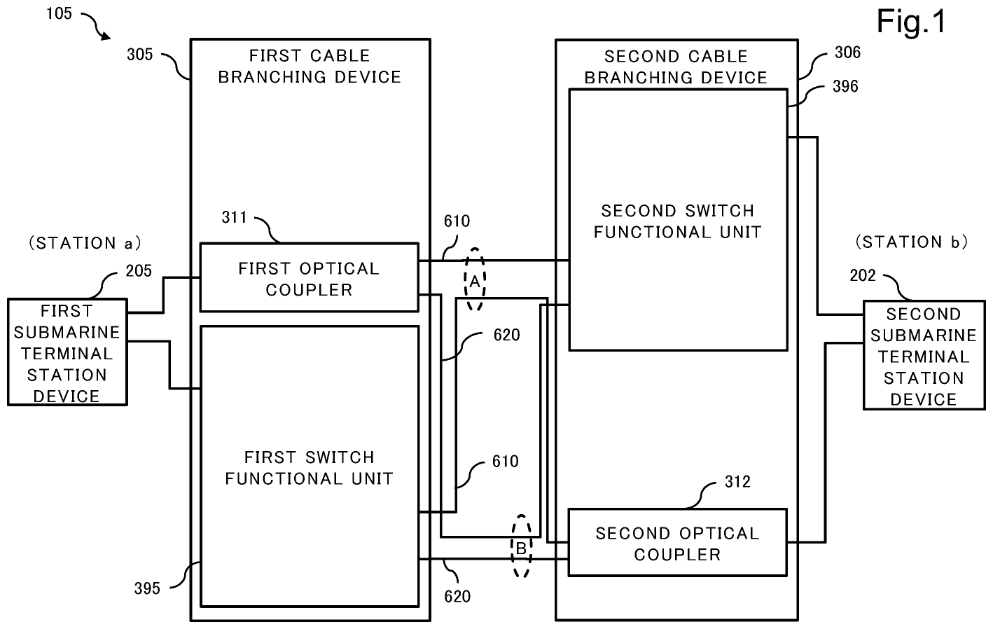

FIG. 1 is a block diagram illustrating one example of a configuration according to the first example embodiment of the present invention.

As illustrated in FIG. 1, a failure detection apparatus 105 according to the present example embodiment includes a first submarine terminal station device 205, a first cable branching device 305, a second cable branching device 306, and a second submarine terminal station device 202.

The first submarine terminal station device 205 (submarine line terminal equipment: SLTE; hereinafter, also referred to as a “station a”) performs conversion of data and an optical wavelength-division multiplexing (WDM) signal between an external device (unillustrated) and a transmission path.

The first cable branching device 305 (branching unit: BU) is connected to the first submarine terminal station device 205 and the second cable branching device 306.

The second cable branching device 306 is connected to the second submarine terminal station device 202 and the first cable branching device 305.

The first cable branching device 305 and the second cable branching device 306 are connected to each other by each of a first submarine optical cable 610 (hereinafter, also referred to as a “route A”) and a second submarine optical cable 620 (hereinafter, also referred to as a “route B”). The first submarine optical cable 610 and the second submarine optical cable 620 mutually have a redundant configuration, one serves as an active transmission path, and another serves as a standby transmission path. For example, each of the first cable branching device 305 and the second cable branching device 306 switches the active transmission path and the standby transmission path when a failure in the active transmission path is detected. For example, each of the first cable branching device 305 and the second cable branching device 306 holds information on the active transmission path. Then, the first submarine terminal station device 205 that has detected a failure in the active transmission path transmits a first active transmission path switching instruction for switching the active transmission path, to a first switch functional unit 395 via a third connection (unillustrated) that is parallel to a first connection between the first submarine terminal station device 205 and the first cable branching device 305. The second submarine terminal station device 202 that has detected a failure in the active transmission path transmits a second active transmission path switching instruction for switching the active transmission path, to a second switch functional unit 396 via a fourth connection (unillustrated) that is parallel to a second connection between the second submarine terminal station device 202 and the second cable branching device 306. Then, each of the first switch functional unit 395 and the second switch functional unit 396 switches the active transmission path in accordance with the received first active transmission path switching instruction or the second active transmission path switching instruction (explanation for a reception mechanism will be omitted). Then, each of the first cable branching device 305 and the second cable branching device 306 updates the information on the active transmission path. A mechanism of switching the active transmission path and the standby transmission path is generally known (see PTL 1), and thus, detailed explanation will be omitted.

The second submarine terminal station device 202 (hereinafter, also referred to as a “station b”) performs conversion of data and a WDM signal between an external device (unillustrated) and a transmission path. The second submarine terminal station device 202 is connected to the second cable branching device 306.

The first submarine terminal station device 205 and the second submarine terminal station device 202 communicate via an active transmission path by using a WDM signal (hereinafter, also referred to simply as a “signal”). The WDM signal is used in order to transmit both of a main signal and a supervisory signal by means of one optical fiber. The signal includes a main signal and a supervisory signal. The main signal is a signal representing data to be exchanged between the station a and the station b. The supervisory signal is a signal for detecting a failure in the routes A and B. It is assumed that the supervisory signal is identifiable by a wavelength from the main signal. Herein, it is assumed that a setting (hereinafter, referred to as a “active transmission path setting”) relating to which of the routes A and B is an active transmission path is held by the first cable branching device 305 and the second cable branching device 306. Further, it is assumed that which of the routes A and B (alternatively, an active transmission path and a standby transmission path) is a transmission path to be tested (hereinafter, referred to as a “test transmission path”) is determined for each test.

The first cable branching device 305 includes a first optical coupler 311 and the first switch functional unit 395.

The first optical coupler 311 includes an input from the station a and outputs to the routes A and B. The first optical coupler 311 splits and outputs a signal received from the station a, to an active transmission path and a standby transmission path (the routes A and B).

The first switch functional unit 395 includes inputs from the routes A and B and an output to the station a. The first switch functional unit 395 transmits a main signal being input from an active transmission path (either the route A or B) and a supervisory signal being input from a test transmission path, to the station a.

The second cable branching device 306 includes a second optical coupler 312 and the second switch functional unit 396.

The second optical coupler 312 includes an input from the station b and outputs to the routes A and B. The second optical coupler 312 splits and outputs a signal received from the second submarine terminal station device 202, to an active transmission path and a standby transmission path.

The second switch functional unit 396 includes inputs from the routes A and B and an output to the station b. The second switch functional unit 396 transmits a main signal being input from an active transmission path and a supervisory signal being input from a test transmission path, to the second submarine terminal station device 202.

An operation according to the present example embodiment will be explained.

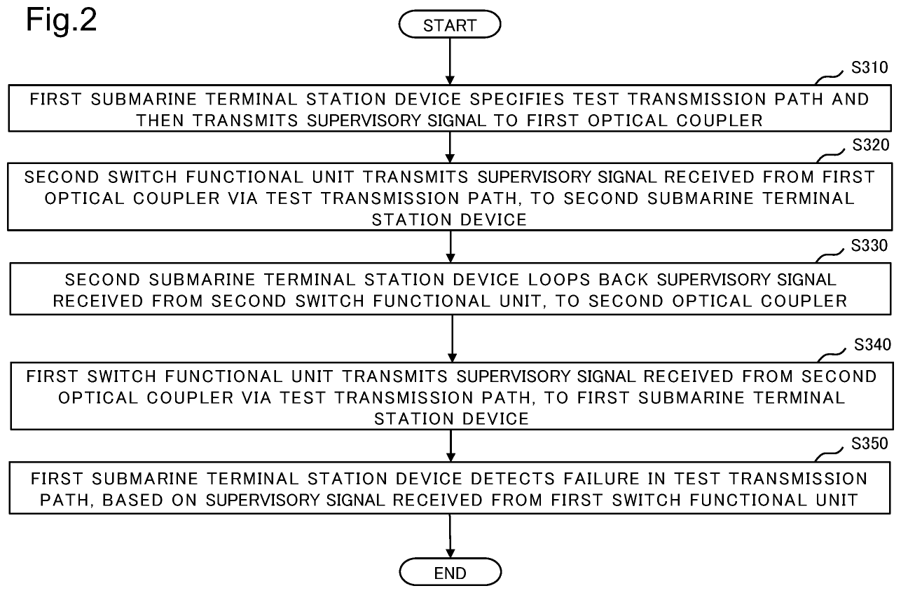

FIG. 2 is a flowchart illustrating an operation according to the first example embodiment of the present invention. The flowchart illustrated in FIG. 2 and explanation therefor are one example, and processing order or the like may be changed, processing may be returned, or processing may be repeated as appropriate according to desired processing.

First, the first submarine terminal station device 205 specifies a test transmission path and then transmits a supervisory signal to the first optical coupler 311 (Step S310). Note that, in order to specify a test transmission path, for example, (1) a management system (unillustrated) that manages an entire system (for example, a submarine cable system) including the failure detection apparatus 105 controls a setting of a test transmission path in the first cable branching device 305 and the second cable branching device 306. Alternatively, (2) the station a may instruct the first switch functional unit 395 and the second switch functional unit 396 to receive a supervisory signal from a test transmission path for a period of time required for one test (alternatively, a period of time required from transmission to reception of a supervisory signal). Alternatively, (3) a test transmission path may be identifiable by a wavelength of a supervisory signal. Alternatively, (4) a test transmission path may be identifiable by a modulation state of a supervisory signal. In a case of (2), for example, the first submarine terminal station device 205 transmits, by using a main signal, a first test transmission path specification instruction for specifying a test transmission path, to the second submarine terminal station device 202. Concurrently, the first submarine terminal station device 205 transmits a second test transmission path specification instruction for specifying a test transmission path, to the first switch functional unit 395 via the third connection (unillustrated) that is parallel to the first connection between the first submarine terminal station device 205 and the first cable branching device 305. The second submarine terminal station device 202 that has received the first test transmission path specification instruction transmits a third test transmission path specification instruction for specifying a test transmission path, to the second switch functional unit 396 via the fourth connection (unillustrated) that is parallel to the second connection between the second submarine terminal station device 202 and the second cable branching device 306. Then, each of the first switch functional unit 395 and the second switch functional unit 396 specifies a test transmission path for a predetermined period of time in accordance with the received second test transmission path specification instruction or the third test transmission path specification instruction (explanation for a reception mechanism will be omitted). In a case of (4), for example, the first submarine terminal station device 205 transmits a supervisory signal modulated by a fourth test transmission path specification instruction for specifying a test transmission path, to the first submarine terminal station device 205. Then, the first switch functional unit 395 and the second switch functional unit 396 demodulate the received supervisory signal (explanation for a demodulation mechanism will be omitted), and identify a test transmission path in accordance with the demodulated fourth test transmission path specification instruction.

Next, the second switch functional unit 396 transmits the supervisory signal received from the first optical coupler 311 via the test transmission path, to the second submarine terminal station device 202 (Step S320).

Subsequently, the second submarine terminal station device 202 loops back the supervisory signal received from the second switch functional unit 396, to the second optical coupler 312 (Step S330).

Subsequently, the first switch functional unit 395 transmits the supervisory signal received from the second optical coupler 312 via the test transmission path, to the first submarine terminal station device 205 (Step S340).

Subsequently, the first submarine terminal station device 205 detects a failure in the test transmission path (an active transmission path or a standby transmission path), based on the supervisory signal received from the first switch functional unit 395 (Step S350). Specifically, the first submarine terminal station device 205 determines presence/absence of a failure, a type of a failure, a failure location, or the like, based on, for example, level fluctuation of the looped-back supervisory signal, a period of time required from transmission to reception of the supervisory signal, or the like.

As explained above, in the failure detection apparatus 105 according to the present example embodiment, the station a transmits a supervisory signal to both of the routes A and B via the first cable branching device 305. Then, the second cable branching device 306 transmits, among supervisory signals transmitted to both of the routes A and B, a supervisory signal received from a test transmission path, to the station b. The station b loops back the supervisory signal received from the second cable branching device 306, to both of the routes A and B via the second cable branching device 306. Then, the first cable branching device 305 transmits, among supervisory signals looped back to both of the routes A and B, a supervisory signal received from the test transmission path, to the station a. Then, the station a detects a failure in the test transmission path, based on the supervisory signal received from the first cable branching device 305. Herein, any of the routes A and B (an active transmission path and a standby transmission path) is specifiable as the test transmission path.

Accordingly, the failure detection apparatus 105 according to the present example embodiment has an advantageous effect that a failure in an active transmission path and a standby transmission path can be detected in an optical submarine cable system in which a submarine optical cable has a redundant configuration. Herein, in the failure detection apparatus 105, a failure in an active transmission path and a standby transmission path can be detected without depending on an active transmission path setting.

Note that, the failure detection apparatus 105 may include at least one fourth repeater on the second connection between the second submarine terminal station device 202 and the second cable branching device 306 when the second submarine terminal station device 202 does not perform loopback of a supervisory signal (see the second example embodiment). Then, the fourth repeater passes a main signal and a supervisory signal, and loops back the supervisory signal on the second connection. Herein, it is assumed that loopback is, when receiving a signal in a certain direction (for example, a direction from the station A to the station B) of a certain transmission path, transmitting the signal in an opposite direction (for example, a direction from the station B to the station A) of the transmission path. This case has an advantageous effect that a failure in an active transmission path and a standby transmission path can be detected even when the second submarine terminal station device 202 does not perform loopback of a supervisory signal.

Further, in the failure detection apparatus 105, each of the first submarine optical cable 610 and the second submarine optical cable 620 may include at least one first repeater and at least one second repeater (see the second example embodiment). Then, each of the first repeater and the second repeater loops back a passed supervisory signal on the first submarine optical cable 610 and the second submarine optical cable 620. This case has an advantageous effect that a type of a failure, a failure location, or the like can be determined in more detail.

Further, the failure detection apparatus 105 may include at least one third repeater on the first connection between the first submarine terminal station device 205 and the first cable branching device 305 (see the second example embodiment). Then, the third repeater loops back a passed supervisory signal on the first connection. This case has an advantageous effect that a type of a failure, a failure location, or the like can be determined in more detail.

### Second Example Embodiment

Next, a second example embodiment of the present invention, which is based on the first example embodiment of the present invention, will be explained. It is assumed that a failure detection apparatus according to the present example embodiment inherits the configuration and the operation according to the first example embodiment of the present invention unless otherwise stated. In the present example embodiment, a filter, an optical switch, and a multiplexer are used for selection of a main signal and a supervisory signal in a cable branching device.

A configuration according to the present example embodiment will be explained.

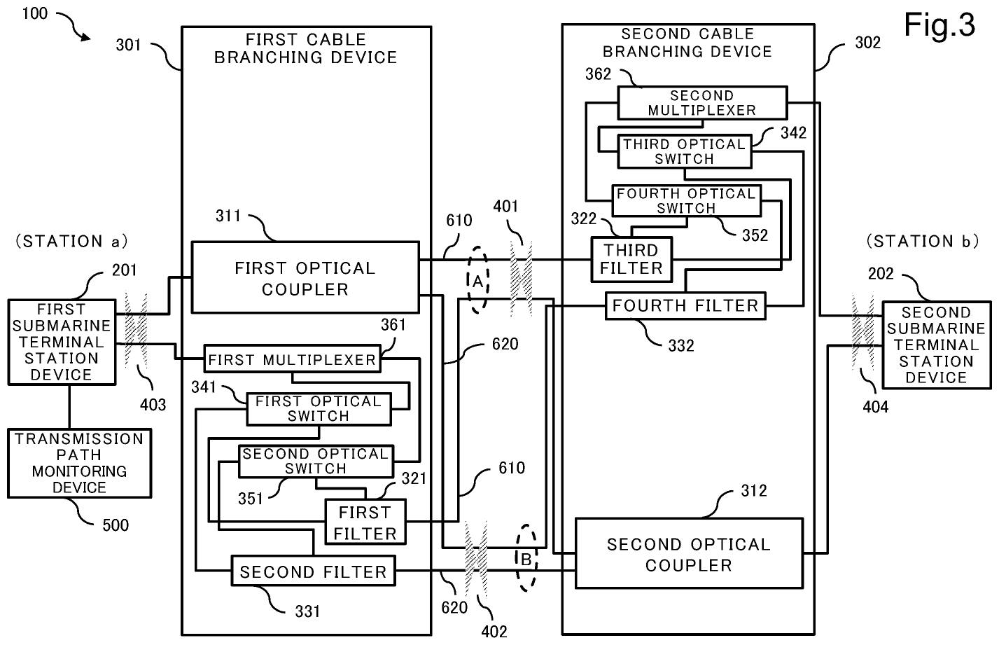

FIG. 3 is a block diagram illustrating one example of a configuration according to the second example embodiment of the present invention.

As illustrated in FIG. 3, a failure detection apparatus 100 according to the present example embodiment includes at least two first submarine optical cables 610, at least two second submarine optical cables 620, a first submarine terminal station device 201 (a station a), a second submarine terminal station device 202 (a station b), a first cable branching device 301, a second cable branching device 302, and a transmission path monitoring device 500.

In the present example embodiment, each of routes A and B includes at least one first repeater 401 and at least one second repeater 402. Further, a first connection between the station a and the first cable branching device 301 includes at least one third repeater 403. Further, a second connection between the station b and the second cable branching device 302 includes at least one fourth repeater 404.

The station a performs conversion of data and a WDM signal between an external device (unillustrated) and a transmission path. Note that, in the present example embodiment, the station a is connected to the transmission path monitoring device 500. Further, in the present example embodiment, the station a may not perform loopback of a supervisory signal.

The first cable branching device 301 is connected to the station a and the second cable branching device 302.

The second cable branching device 302 is connected to the station b and the first cable branching device 301.

The first cable branching device 301 and the second cable branching device 302 are connected to each other by each of the route A and the route B.

The station b performs conversion of data and a WDM signal between an external device (unillustrated) and a transmission path.

The station a and the station b communicate via an active transmission path by using a WDM signal.

The first cable branching device 301 includes a first optical coupler 311, a first filter 321, a second filter 331, a first optical switch 341, a second optical switch 351, and a first multiplexer 361.

The second cable branching device 302 includes a second optical coupler 312, a third filter 322, a fourth filter 332, a third optical switch 342, a fourth optical switch 352, and a second multiplexer 362.

The first optical coupler 311 splits and transmits a signal received from the station a, to the route A and the route B.

The first optical switch 341 includes an input from the first filter 321, an input from the second filter 331, and an output to the first multiplexer 361. The first optical switch 341 outputs, among main signals being output by the first filter 321 or the second filter 331, a main signal received from an active transmission path.

The first filter 321 includes an input from the route A, an output to the first optical switch 341, and an output to the second optical switch 351. The first filter 321 demultiplexes and outputs, among signals received from the second optical coupler 312 via the route A, a supervisory signal to the second optical switch 351 and a main signal to the first optical switch 341.

The second filter 331 includes an input from the route B, an output to the first optical switch 341, and an output to the second optical switch 351. The second filter 331 demultiplexes and outputs, among signals received from the second optical coupler 312 via the route B, a supervisory signal to the second optical switch 351 and a main signal to the first optical switch 341.

The second optical switch 351 includes an input from the first filter 321, an input from the second filter 331, and an output to the first multiplexer 361. The second optical switch 351 outputs, among supervisory signals being output by the first filter 321 or the second filter 331, a supervisory signal received from a test transmission path.

The first multiplexer 361 includes an input from the first optical switch 341, an input from the second optical switch 351, and an output to the station a. The first multiplexer 361 multiplexes a main signal being output from the first optical switch 341 and a supervisory signal being output from the second optical switch 351, and transmits the multiplexed signal to the station a.

The second optical coupler 312 splits and transmits a signal received from the station b to the route A and the route B.

The third optical switch 342 includes an input from the third filter 322, an input from the fourth filter 332, and an output to the second multiplexer 362. The third optical switch 342 outputs, among main signals being output by the third filter 322 or the fourth filter 332, a main signal received from an active transmission path.

The third filter 322 includes an input from the route A, an output to the third optical switch 342, and an output to the fourth optical switch 352. The third filter 322 demultiplexer and outputs, among signals received from the first optical coupler 311 via the route A, a supervisory signal to the fourth optical switch 352 and a main signal to the third optical switch 342.

The fourth filter 332 includes an input from the route B, an output to the third optical switch 342, and an output to the fourth optical switch 352. The fourth filter 332 demultiplexes and outputs, among signals received from the first optical coupler 311 via the route B, a supervisory signal to the fourth optical switch 352 and a main signal to the third optical switch 342.

The fourth optical switch 352 includes an input from the third filter 322, an input from the fourth filter 332, and an output to the second multiplexer 362. The fourth optical switch 352 outputs, among supervisory signals being output by the third filter 322 or the fourth filter 332, a supervisory signal received from a test transmission path.

The second multiplexer 362 includes an input from the third optical switch 342, an input from the fourth optical switch 352, and an output to the station b. The second multiplexer 362 multiplexes a main signal being output from the third optical switch 342 and a supervisory signal being output from the fourth optical switch 352, and transmits the multiplexed signal to the station b.

Each of the first repeater 401, the second repeater 402, the third repeater 403, and the fourth repeater 404 includes a first input from any one direction (for example, a direction from the station a to the station b; referred to as a forward direction) of a certain transmission path, a first output to the forward direction of the transmission path, a second input from a direction (for example, a direction from the station b to the station a; referred to simply as a “reverse direction”) reverse to the forward direction of the transmission path, and a second output to the reverse direction of the transmission path. Each of the first repeater 401, the second repeater 402, the third repeater 403, and the fourth repeater 404 passes the first input to the first output, and the second input to the second output, and loops back a supervisory signal from the first input to the second output, and a supervisory signal from the second input to the first output. Consequently, each of supervisory signals being input from the first input and the second input of a transmission path is output (passed) to the first output and the second output of the transmission path, and, concurrently, is output (looped back) to the second output and the first output of the transmission path.

The first repeater 401 passes a main signal and a supervisory signal and loops back the supervisory signal on the route A. The first repeater 401 is an optical submarine repeater that has, for example, a loopback function using a reflection-type optical filter and an amplification/repeating function using an erbium-doped fiber.

The second repeater 402 passes a main signal and a supervisory signal and loops back the supervisory signal on the route B. The second repeater 402 is an optical submarine repeater that has, for example, a loopback function using a reflection-type optical filter and an amplification/repeating function using an erbium-doped fiber.

The third repeater 403 passes a main signal and a supervisory signal and loops back the supervisory signal on the first connection. The third repeater 403 is, for example, an optical fiber partial reflector (in-line type).

The fourth repeater 404 passes a main signal and a supervisory signal and loops back the supervisory signal on the second connection. The fourth repeater 404 is, for example, an optical fiber partial reflector (in-line type).

The transmission path monitoring device 500 instructs the station a to transmit a supervisory signal, and detects a failure in the route A and the route B, based on the looped-back supervisory signal received from the station a.

Other configurations according to the present example embodiment are similar to the configurations according to the first example embodiment.

An operation according to the present example embodiment will be explained.

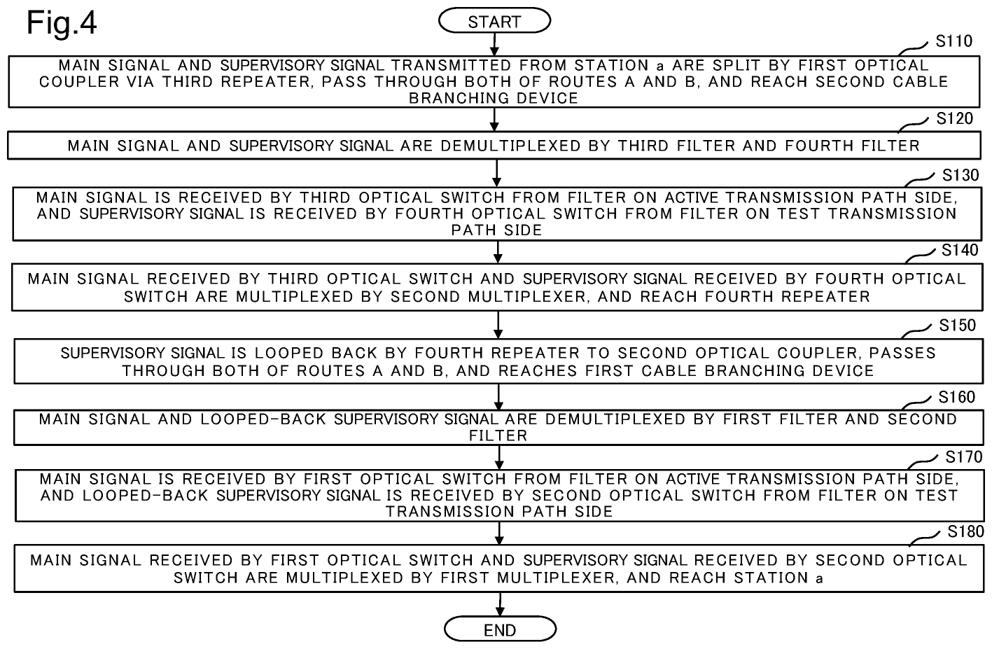

FIG. 4 is a sequence diagram illustrating one example of an operation according to the second example embodiment of the present invention.

Herein, it is assumed that there is no malfunction occurring in the failure detection apparatus 100. In this case, a main signal and a supervisory signal are passed and the supervisory signal is looped back (hereinafter, also referred to simply as the supervisory signal “is looped back”) at the first repeater 401, the second repeater 402, the third repeater 403, and the fourth repeater 404. However, hereinafter, loopback of a supervisory signal at the fourth repeater 404 will be explained as a representative example.

First, for example, it is assumed that a management system (unillustrated) sets a test transmission path (for example, the route B) in the first cable branching device 301 and the second cable branching device 302. Then, it is assumed that the transmission path monitoring device 500 instructs the station a to transmit a supervisory signal in a state where a test transmission path is specified.

Next, a main signal and a supervisory signal transmitted from the station a are split by the first optical coupler 311 via the third repeater 403, pass through both of the routes A and B (via the first repeater 401 and the second repeater 402), and reach the second cable branching device 302 (Step S110). Herein, the supervisory signal is looped back in a direction from the station b to the station a at the first repeater 401, the second repeater 402, and the third repeater 403.

Subsequently, the main signal and the supervisory signal are demultiplexed by the third filter 322 and the fourth filter 332 in the second cable branching device 302 (Step S120).

Subsequently, the main signal is received by the third optical switch 342 from a filter (for example, the third filter 322) on a side of an active transmission path (for example, the route A). Meanwhile, the supervisory signal is received by the fourth optical switch 352 from a filter (for example, the fourth filter 332) on a side of a test transmission path (for example, the route B) (Step S130). Herein, the test transmission path is independently selectable without depending on which of the routes A and B is the active transmission path.

Subsequently, the main signal received by the third optical switch 342 and the supervisory signal received by the fourth optical switch 352 are multiplexed by the second multiplexer 362 and reach the fourth repeater 404 (Step S140).

Further, the supervisory signal reaching the fourth repeater 404 is looped back by the fourth repeater 404 to the second optical coupler 312, passes through both of the routes A and B, and reaches the first cable branching device 301 (Step S150). Herein, the main signal and the supervisory signal multiplexed by the second multiplexer 362 reach the station b as well. Then, the station b transmits the main signal to the second optical coupler 312.

Subsequently, the main signal and the looped-back supervisory signal are demultiplexed by the first filter 321 and the second filter 331 in the first cable branching device 301 (Step S160).

Subsequently, the main signal is received by the first optical switch 341 from a filter (for example, the first filter 321) on a side of the active transmission path (for example, the route A). Meanwhile, the looped-back supervisory signal is received by the second optical switch 351 from a filter (for example, the second filter 331) on a side of the test transmission path (for example, the route B) (Step S170). Herein, it is assumed that the test transmission path is identical to the test transmission path for the fourth optical switch 352 in Step S130.

Subsequently, the main signal received by the first optical switch 341 and the supervisory signal received by the second optical switch 351 are multiplexed by the first multiplexer 361, and reach the station a (Step S180).

As a result of the above operation, when there is no malfunction occurring in the failure detection apparatus 100, a supervisory signal is looped back from the first repeater 401, the second repeater 402, and the third repeater 403 to the station a, similarly to from the fourth repeater 404.

Meanwhile, when there is a malfunction occurring in any transmission path in the failure detection apparatus 100, any supervisory signal is not looped back, or abnormality occurs in a looped-back supervisory signal.

Then, the transmission path monitoring device 500 detects a failure in a transmission path, based on the looped-back supervisory signal received from the station a via the test transmission path (for example, the route B).

Similarly, for example, it is assumed this time that a management system (unillustrated) switches a setting of a test transmission path (for example, the route A) in the first cable branching device 301 and the second cable branching device 302. Then, the transmission path monitoring device 500 instructs the station a to transmit a supervisory signal in a state where a test transmission path is switched, and detects a failure in a transmission path, based on the looped-back supervisory signal received from the station a via the test transmission path (for example, the route A). Consequently, a supervisory signal looped-back from each of the first repeater 401 and the second repeater 402 is identified by a specified test transmission path. Further, a supervisory signal looped-back from each of the third repeater 403, the first repeater 401, and the fourth repeater 404 is identified based on, for example, a time difference required from transmission to reception of the supervisory signal. Further, a supervisory signal looped-back from each of the third repeater 403, the second repeater 402, and the fourth repeater 404 is identified based on, for example, a time difference required from transmission to reception of the supervisory signal.

Other operations according to the present example embodiment are similar to the operations according to the first example embodiment.

As described above, in the failure detection apparatus 100 according to the present example embodiment, the first cable branching device 301 transmits a supervisory signal to both of the routes A and B via the first cable branching device 301 and the second cable branching device 302. Then, the supervisory signal transmitted to both of the routes A and B is looped back by the first repeater 401, the second repeater 402, the third repeater 403, or the fourth repeater 404. Then, the first cable branching device 301 and the second cable branching device 302 transmit the supervisory signal looped back from a test transmission path, to the station a. Herein, the test transmission path is independently selectable without depending on an active transmission path. Then, the transmission path monitoring device 500 detects a failure in a transmission path, based on the looped-back supervisory signal received from the station a.

Accordingly, the failure detection apparatus 100 according to the present example embodiment has an advantageous effect that a failure in an active transmission path and a standby transmission path can be detected in an optical submarine cable system in which a submarine optical cable has a redundant configuration. Herein, in the failure detection apparatus 100, a failure in an active transmission path and a standby transmission path can be detected without depending on an active transmission path setting.

### Third Example Embodiment

Next, a third example embodiment of the present invention, which is based on the second example embodiment of the present invention, will be explained. It is assumed that a failure detection apparatus according to the present example embodiment inherits the configuration and the operation according to the second example embodiment of the present invention unless otherwise stated. In the present example embodiment, a wavelength selective switch (WSS) and a multiplexer are used for selection of a main signal and a supervisory signal in a cable branching device.

A configuration according to the present example embodiment will be explained.

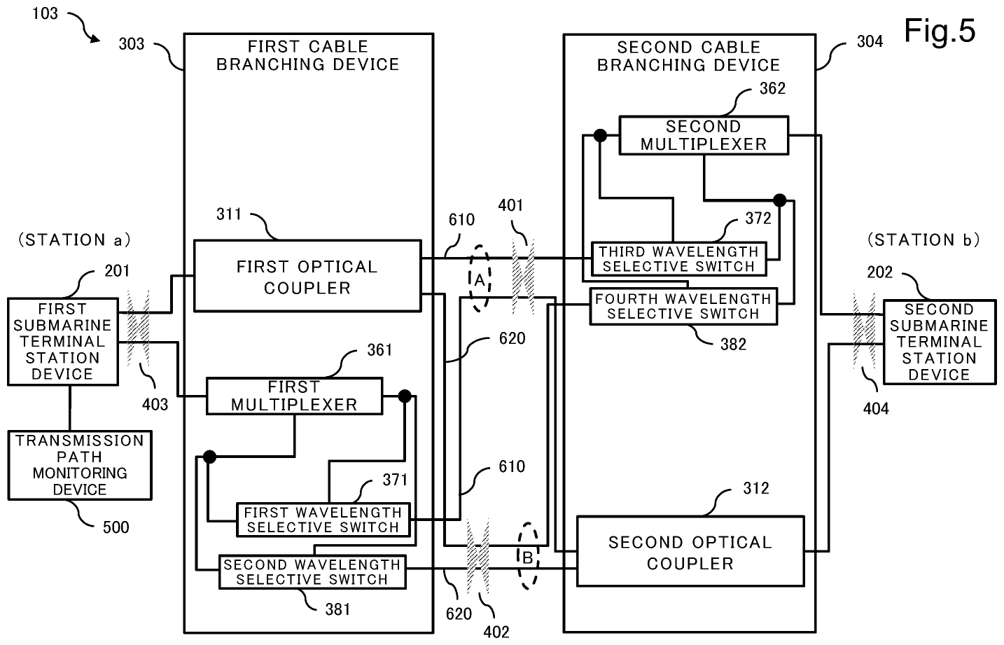

FIG. 5 is a block diagram illustrating one example of a configuration according to the third example embodiment of the present invention.

As illustrated in FIG. 5, a failure detection apparatus 103 according to the present example embodiment includes at least two first submarine optical cables 610, at least two second submarine optical cables 620, a first submarine terminal station device 201 (a station a), a second submarine terminal station device 202 (a station b), a first cable branching device 303, a second cable branching device 304, and a transmission path monitoring device 500.

The first cable branching device 303 is connected to the station a and the second cable branching device 304.

The second cable branching device 304 is connected to the station b and the first cable branching device 303.

The first cable branching device 303 and the second cable branching device 304 are connected to each other by each of a route A and a route B.

The first cable branching device 303 includes a first optical coupler 311, a first wavelength selective switch 371, a second wavelength selective switch 381, and a first multiplexer 361.

The second cable branching device 304 includes a second optical coupler 312, a third wavelength selective switch 372, a fourth wavelength selective switch 382, and a second multiplexer 362.

The first wavelength selective switch 371 includes an input from the route A, a first output to an input for inputting a main signal of the first multiplexer 361, and a second output to an input for inputting a supervisory signal of the first multiplexer 361. The first wavelength selective switch 371 switches and outputs, among signals received from the second optical coupler 312 via the first submarine optical cable 610, a supervisory signal received from a test transmission path to the second output and a main signal received from an active transmission path to the first output. Herein, the first wavelength selective switch 371 performs control of receiving a supervisory signal from a test transmission path according to a method of specifying a test transmission path described above in Step S310 in the first example embodiment.

The second wavelength selective switch 381 includes an input from the route B, a first output to an input for inputting a main signal of the first multiplexer 361, and a second output to an input for inputting a supervisory signal of the first multiplexer 361. The second wavelength selective switch 381 switches and outputs, among signals received from the second optical coupler 312 via the second submarine optical cable 620, a supervisory signal received from a test transmission path to the second output and a main signal received from an active transmission path to the first output. Herein, the second wavelength selective switch 381 performs control of receiving a supervisory signal from a test transmission path according to the method of specifying a test transmission path described above in Step S310 in the first example embodiment.

The first multiplexer 361 includes a first input for inputting a main signal from the first wavelength selective switch 371 and the second wavelength selective switch 381, a second input for inputting a supervisory signal from the first wavelength selective switch 371 and the second wavelength selective switch 381, and an output to the first submarine terminal station device 201. The first multiplexer 361 multiplexes a supervisory signal being output from the first wavelength selective switch 371 or the second wavelength selective switch 381 and a main signal being output from the first wavelength selective switch 371 or the second wavelength selective switch 381, and transmits the multiplexed signal to the first submarine terminal station device 201.

The third wavelength selective switch 372 includes an input from the route A, a first output to an input for inputting a main signal of the second multiplexer 362, and a second output to an input for inputting a supervisory signal of the second multiplexer 362. The third wavelength selective switch 372 switches and outputs, among signals received from the first optical coupler 311 via the first submarine optical cable 610, a supervisory signal received from a test transmission path to the second output and a main signal received from an active transmission path to the first output. Herein, the third wavelength selective switch 372 performs control of receiving a supervisory signal from a test transmission path according to the method of specifying a test transmission path described above in Step S310 in the first example embodiment.

The fourth wavelength selective switch 382 includes an input from the route B, a first output to an input for inputting a main signal of the second multiplexer 362, and a second output to an input for inputting a supervisory signal of the second multiplexer 362. The fourth wavelength selective switch 382 switches and outputs, among signals received from the first optical coupler 311 via the second submarine optical cable 620, a supervisory signal received from a test transmission path to the second output and a main signal received from an active transmission path to the first output. Herein, the fourth wavelength selective switch 382 performs control of receiving a supervisory signal from a test transmission path according to the method of specifying a test transmission path described above in Step S310 in the first example embodiment.

The second multiplexer 362 includes a first input for inputting a main signal from the third wavelength selective switch 372 and the fourth wavelength selective switch 382, a second input for inputting a supervisory signal from the third wavelength selective switch 372 and the fourth wavelength selective switch 382, and an output to the second submarine terminal station device 202. The second multiplexer 362 multiplexes a supervisory signal being output from the third wavelength selective switch 372 or the fourth wavelength selective switch 382 and a main signal being output from the third wavelength selective switch 372 or the fourth wavelength selective switch 382, and transmits the multiplexed signal to the second submarine terminal station device 202.

Other configurations according to the present example embodiment are similar to the configurations according to the second example embodiment.

An operation according to the present example embodiment will be explained.

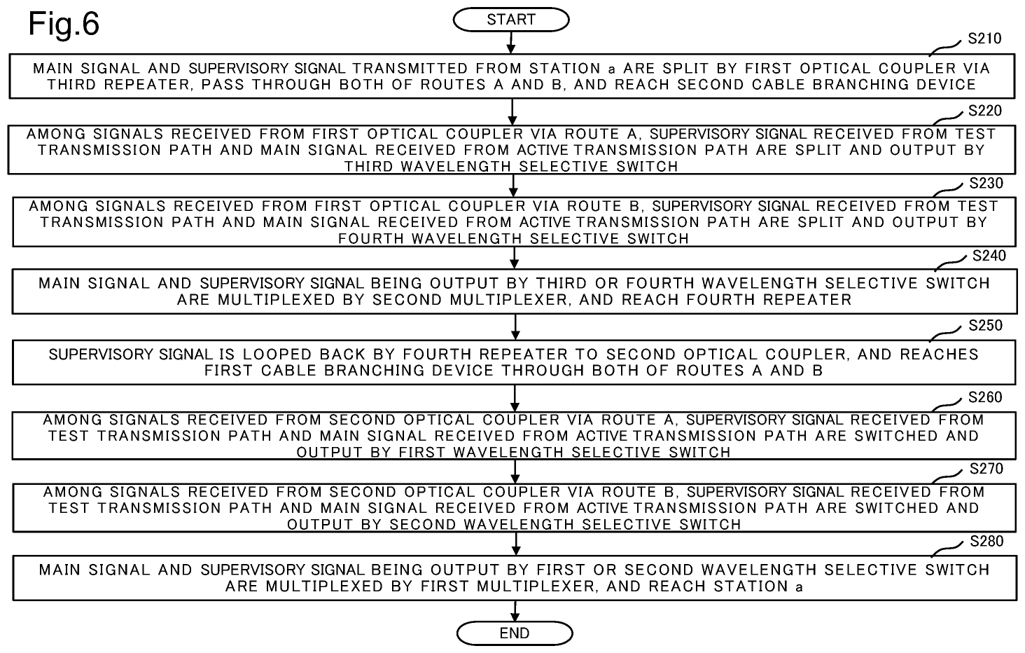

FIG. 6 is a sequence diagram illustrating one example of an operation according to the third example embodiment of the present invention.

Herein, it is assumed that there is no malfunction occurring in the failure detection apparatus 103. In this case, a main signal and a supervisory signal are passed and the supervisory signal is looped back (hereinafter, also referred to simply as the supervisory signal “is looped back”) at the first repeater 401, the second repeater 402, the third repeater 403, and the fourth repeater 404. However, hereinafter, loopback of a supervisory signal at the fourth repeater 404 will be explained as a representative example.

First, for example, it is assumed that a management system (unillustrated) sets a test transmission path (for example, the route B) in the first cable branching device 303 and the second cable branching device 304. Then, it is assumed that the transmission path monitoring device 500 instructs the station a to transmit a supervisory signal in a state where a test transmission path is specified.

Next, a main signal and a supervisory signal transmitted from the station a are split by the first optical coupler 311 via the third repeater 403, pass through both of the routes A and B (via the first repeater 401 and the second repeater 402), and reach the second cable branching device 304 (Step S210). Herein, the supervisory signal is looped back in a direction from the station b to the station a at the first repeater 401, the second repeater 402, and the third repeater 403.

Subsequently, among signals received from the first optical coupler 311 via the route A, the supervisory signal received from the test transmission path (for example, the supervisory signal is absent when the test transmission path is the route B) and the main signal received from an active transmission path (for example, the route A) are switched and output by the third wavelength selective switch 372 (Step S220).

Meanwhile, among signals received from the first optical coupler 311 via the route B, the supervisory signal received from the test transmission path (for example, when the test transmission path is the route B) and the main signal received from the active transmission path (for example, the main signal is absent when the active transmission path is the route A) are switched and output by the fourth wavelength selective switch 382 (Step S230). Herein, the test transmission path is independently selectable without depending on which of the routes A and B is the active transmission path.

Subsequently, the main signal being output by the third wavelength selective switch 372 or the fourth wavelength selective switch 382 and the supervisory signal being output by the third wavelength selective switch 372 or the fourth wavelength selective switch 382 are multiplexed by the second multiplexer 362, and reach the fourth repeater 404 (Step S240).

Further, the supervisory signal reaching the fourth repeater 404 is looped back by the fourth repeater 404 to the second optical coupler 312, passes through both of the routes A and B, and reaches the first cable branching device 303 (Step S250). Herein, the main signal and the supervisory signal multiplexed by the second multiplexer 362 reach the station b as well. Then, the station b transmits the main signal to the second optical coupler 312.

Subsequently, among signals received from the second optical coupler 312 via the route A, the supervisory signal received from the test transmission path (for example, the supervisory signal is absent when the test transmission path is the route B) and the main signal received from the active transmission path (for example, the route A) are switched and output by the first wavelength selective switch 371 (Step S260).

Meanwhile, among signals received from the second optical coupler 312 via the route B, the supervisory signal received from the test transmission path (for example, when the test transmission path is the route B) and the main signal received from the active transmission path (for example, the main signal is absent when the active transmission path is the route A) are switched and output by the second wavelength selective switch 381 (Step S270). Herein, it is assumed that the test transmission path is identical to the test transmission path for the fourth wavelength selective switch 382 in Step S230.

Subsequently, the main signal being output by the first wavelength selective switch 371 or the second wavelength selective switch 381 and the supervisory signal being output by the first wavelength selective switch 371 or the second wavelength selective switch 381 are multiplexed by the first multiplexer 361, and reach the station a (Step S280).

As a result of the above operation, when there is no malfunction occurring in the failure detection apparatus 103, a supervisory signal is looped back from the first repeater 401, the second repeater 402, and the third repeater 403 to the station a, similarly to from the fourth repeater 404.

Meanwhile, when there is a malfunction occurring in any transmission path in the failure detection apparatus 103, any supervisory signal is not looped back, or abnormality occurs in a looped-back supervisory signal.

Then, the transmission path monitoring device 500 detects a failure in a transmission path, based on the looped-back supervisory signal received from the station a via the test transmission path (for example, the route B).

Similarly, for example, it is assumed this time that a management system (unillustrated) switches a setting of a test transmission path (for example, the route A) in the first cable branching device 303 and the second cable branching device 304. Then, the transmission path monitoring device 500 instructs the station a to transmit a supervisory signal in a state where a test transmission path is switched, and detects a failure in a transmission path, based on the looped-back supervisory signal received from the station a via the test transmission path (for example, the route A).

Other operations according to the present example embodiment are similar to the operations according to the second example embodiment.

As described above, in the failure detection apparatus 103 according to the present example embodiment, the first cable branching device 303 transmits a supervisory signal to both of the routes A and B via the first cable branching device 303 and the second cable branching device 304. Then, the supervisory signal transmitted to both of the routes A and B is looped back by the first repeater 401, the second repeater 402, the third repeater 403, or the fourth repeater 404. Then, the first cable branching device 303 and the second cable branching device 304 transmit the supervisory signal looped back from a test transmission path, to the station a. Herein, the test transmission path is independently selectable without depending on an active transmission path. Then, the transmission path monitoring device 500 detects a failure in a transmission path, based on the looped-back supervisory signal received from the station a.

Accordingly, the failure detection apparatus 103 according to the present example embodiment has an advantageous effect that a failure in an active transmission path and a standby transmission path can be detected in an optical submarine cable system in which a submarine optical cable has a redundant configuration. Herein, in the failure detection apparatus 103, a failure in an active transmission path and a standby transmission path can be detected without depending on an active transmission path setting.

### Fourth Example Embodiment

A fourth example embodiment of the present invention, which is basic to each example embodiment of the present invention, will be explained.

A configuration according to the present example embodiment will be explained.

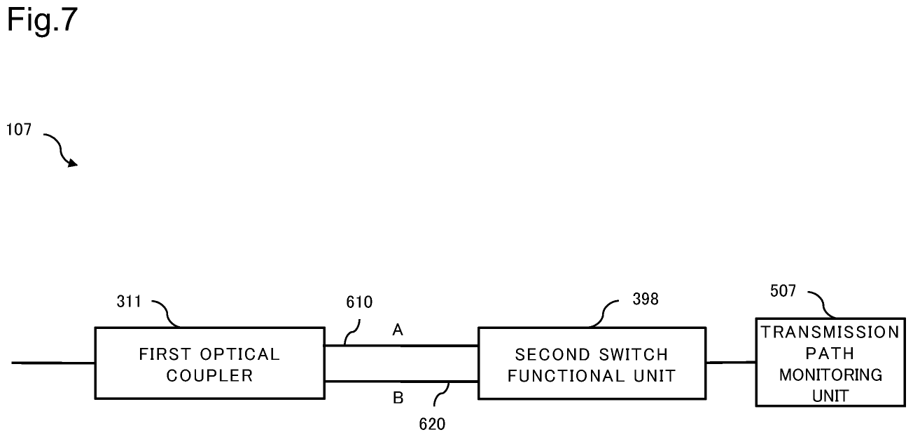

FIG. 7 is a block diagram illustrating one example of a configuration according to the fourth example embodiment of the present invention.

As illustrated in FIG. 7, a failure detection apparatus 107 according to the present example embodiment includes a first optical coupler 311, a second switch functional unit 398, and a transmission path monitoring unit 507.

The second switch functional unit 398 is connected to the transmission path monitoring unit 507 and the first optical coupler 311.

The first optical coupler 311 and the second switch functional unit 398 are connected to each other by each of a first submarine optical cable 610 (hereinafter, also referred to as a “route A”) and a second submarine optical cable 620 (hereinafter, also referred to as a “route B”).

The first submarine optical cable 610 and the second submarine optical cable 620 mutually form a redundant configuration, one serves as an active transmission path, and another serves as a standby transmission path. For example, the second switch functional unit 398 switches the active transmission path and the standby transmission path when a failure in the active transmission path is detected. For example, the second switch functional unit 398 holds information on the active transmission path. Then, the transmission path monitoring unit 507 that has detected a failure in the active transmission path transmits an active transmission path switching instruction for switching the active transmission path, to the second switch functional unit 398 via another connection (unillustrated) that is parallel to a connection between the transmission path monitoring unit 507 and the second switch functional unit 398. Then, the second switch functional unit 398 switches the active transmission path in accordance with the received active transmission path switching instruction (explanation for a reception mechanism will be omitted). Then, the second switch functional unit 398 updates the information on the active transmission path. A mechanism for switching the active transmission path and the standby transmission path is generally known (see PTL 1), and thus, detailed explanation will be omitted.

A signal being transmitted through the routes A and B includes a supervisory signal. The supervisory signal is a signal for detecting a failure in the routes A and B.

It is assumed that a setting (hereinafter, referred to as a “active transmission path setting”) relating to which of the routes A and B is an active transmission path is held by the second switch functional unit 398.

Further, it is assumed that which of the routes A and B (alternatively, an active transmission path and a standby transmission path) is a transmission path to be tested (hereinafter, referred to as a “test transmission path”) is determined for each test.

The first optical coupler 311 includes an input from a signal transmission source and outputs to the routes A and B. The first optical coupler 311 splits and outputs a signal received from the signal transmission source to an active transmission path and a standby transmission path (the routes A and B).

The second switch functional unit 398 includes inputs from the routes A and B and an output to a signal transmission destination. The second switch functional unit 398 transmits a supervisory signal being input from a test transmission path, to the signal transmission destination (the transmission path monitoring unit 507).

An operation according to the present example embodiment will be explained.

First, a signal transmission source transmits a supervisory signal to the first optical coupler 311.

Next, the second switch functional unit 398 transmits the supervisory signal received from the first optical coupler 311 via a test transmission path, to the transmission path monitoring unit 507. Herein, it is assumed that the transmission path monitoring unit 507 has specified a test transmission path for the second switch functional unit 398. Note that, in order to specify a test transmission path, for example, the transmission path monitoring unit 507 may instruct the second switch functional unit 398 to receive a supervisory signal from a test transmission path for a period of time required for one test (alternatively, a period of time required from transmission to reception of a supervisory signal). In this case, for example, the transmission path monitoring unit 507 transmits a test transmission path specification instruction for specifying a test transmission path, to the second switch functional unit 398 via another connection (unillustrated) that is parallel to a connection between the transmission path monitoring unit 507 and the second switch functional unit 398. Then, the second switch functional unit 398 specifies a test transmission path for a predetermined period of time in accordance with the received test transmission path specification instruction (explanation for a reception mechanism will be omitted).

Subsequently, the transmission path monitoring unit 507 detects a failure in the test transmission path (an active transmission path or a standby transmission path), based on the supervisory signal received from the second switch functional unit 398. Specifically, the transmission path monitoring unit 507 determines presence/absence of a failure, a type of a failure, a failure location (the route A or B), or the like, based on, for example, level fluctuation of the received supervisory signal, the test transmission path, or the like.

As explained above, in the failure detection apparatus 107 according to the present example embodiment, the second switch functional unit 398 transmits, among supervisory signals transmitted from a signal transmission source to both of the routes A and B via the first optical coupler 311, a supervisory signal received from a test transmission path, to the transmission path monitoring unit 507. Then, the transmission path monitoring unit 507 detects a failure in the test transmission path, based on the supervisory signal received from the second switch functional unit 398. Herein, any of the routes A and B (an active transmission path and a standby transmission path) is specifiable as the test transmission path.

Accordingly, the failure detection apparatus 107 according to the present example embodiment has an advantageous effect that a failure in an active transmission path and a standby transmission path can be detected in an optical submarine cable system in which a submarine optical cable has a redundant configuration. Herein, in the failure detection apparatus 107, a failure in an active transmission path and a standby transmission path can be detected without depending on an active transmission path setting.

Note that, in the failure detection apparatus 107, a main signal that is optical wavelength-division multiplexed with a supervisory signal may be further input to the first optical coupler 311 (see the first example embodiment).

Further, in the failure detection apparatus 107, the second switch functional unit 398 may output a main signal being output from an active transmission path, to an output destination different from a transmission path monitoring unit on a reception side (for example, a submarine terminal station device on a reception side) (see the first example embodiment).

Further, the failure detection apparatus 107 may further include a transmission-side cable branching device including a first optical coupler and a reception-side cable branching device including a second switch functional unit (see the first example embodiment).

Further, in the failure detection apparatus 107, a supervisory signal transmitted from a transmission source may be looped back, on a transmission path leading to a signal transmission destination, in a direction from the transmission destination to the transmission source (see the first example embodiment). In this case, the failure detection apparatus 107 further includes a transmission-side cable branching device including the first optical coupler 311 and a transmission-side switch functional unit and a reception-side cable branching device including a reception-side optical coupler and the second switch functional unit 398. Then, the transmission-side device can control execution of a test for a transmission path.

Further, in the failure detection apparatus 107, the transmission path monitoring unit 507 may be included in the reception-side cable branching device together with the second switch functional unit 398. Alternatively, the transmission path monitoring unit 507 may be included in the transmission-side cable branching device together with the first optical coupler 311 (however, when the loopback of a supervisory signal described in the first example embodiment is performed). Alternatively, the transmission path monitoring unit 507 may be included in a reception-side submarine terminal station device, or may be included in a transmission-side submarine terminal station device (see the first example embodiment). Alternatively, the transmission path monitoring unit 507 may be included in a reception-side transmission path monitoring device, or may be included in a transmission-side transmission path monitoring device (see the second example embodiment and the third example embodiment).

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. In such a case, a new example embodiment added with such changes or modifications can also be included in the technical scope of the present invention. This is apparent from the matter described in the claims.

The whole or part of the above-described example embodiments can be described as, but not limited to, the following supplementary notes.

### Supplementary Note 1

A failure detection apparatus including:
a first optical coupler that splits and outputs a supervisory signal to an active transmission path and a standby transmission path;
a second switch functional unit that outputs the supervisory signal being output from a test transmission path that is specified one of the active transmission path and the standby transmission path; and
a transmission path monitoring unit that detects a failure in the test transmission path, based on the supervisory signal received from the second switch functional unit.

### Supplementary Note 2

The failure detection apparatus according to supplementary note 1, wherein
a main signal that is optical wavelength-division multiplexed with the supervisory signal is further input to the first optical coupler, and
the second switch functional unit outputs the main signal being output from the active transmission path, to an output destination different from the transmission path monitoring unit.

### Supplementary Note 3

The failure detection apparatus according to supplementary note 2, wherein
the first optical coupler and the second switch functional unit are connected by a first submarine optical cable that can be any one of the active transmission path and the standby transmission path and a second submarine optical cable that can be another of the active transmission path and the standby transmission path, and
the second switch functional unit includes:
   a third filter that demultiplexes and outputs, among signals received from the first optical coupler via the first submarine optical cable, the supervisory signal and a main signal;
   a fourth filter that demultiplexes and outputs, among signals received from the first optical coupler via the second submarine optical cable, the supervisory signal and a main signal;
   a third optical switch that outputs, among main signals being output by the third filter or the fourth filter, a main signal received from the active transmission path;
   a fourth optical switch that outputs, among the supervisory signals being output by the third filter or the fourth filter, the supervisory signal received from the test transmission path; and
   a second multiplexer that multiplexes a main signal being output from the third optical switch and the supervisory signal being output from the fourth optical switch, and transmits the multiplexed signal to the transmission path monitoring unit.

### Supplementary Note 4

The failure detection apparatus according to supplementary note 2, wherein
the first optical coupler and the second switch functional unit are connected by a first submarine optical cable that can be any one of the active transmission path and the standby transmission path and a second submarine optical cable that can be another of the active transmission path and the standby transmission path, and
the second switch functional unit includes:
   a third wavelength selective switch that switches and outputs, among signals received from the first optical coupler via the first submarine optical cable, the supervisory signal received from the test transmission path and a main signal received from the active transmission path;
   a fourth wavelength selective switch that switches and outputs, among signals received from the first optical coupler via the second submarine optical cable, the supervisory signal received from the test transmission path and a main signal received from the active transmission path; and
   a second multiplexer that multiplexes the supervisory signal being output from the third wavelength selective switch or the fourth wavelength selective switch and a main signal being output from the third wavelength selective switch or the fourth wavelength selective switch, and transmits the multiplexed signal to the transmission path monitoring unit.

### Supplementary Note 5

The failure detection apparatus according to supplementary note 2, further including:
a first submarine terminal station device;
a second submarine terminal station device;
a second optical coupler that splits and outputs a main signal and the looped-back supervisory signal to the active transmission path and the standby transmission path; and
a first switch functional unit that outputs the looped-back supervisory signal being output from the test transmission path, to the transmission path monitoring unit, and outputs a main signal being output from the active transmission path, to the first submarine terminal station device, wherein
the second switch functional unit outputs the supervisory signal being output from the test transmission path and a main signal being output from the active transmission path, to the second submarine terminal station device,
the second submarine terminal station device loops back the supervisory signal received from the second switch functional unit, and
the transmission path monitoring unit detects a failure in the test transmission path, based on the looped-back supervisory signal received from the first switch functional unit.

### Supplementary Note 6

The failure detection apparatus according to supplementary note 5, further including:
a first cable branching device that includes the first optical coupler and the first switch functional unit; and
a second cable branching device that includes the second optical coupler and the second switch functional unit, wherein
the first optical coupler and the second switch functional unit are connected by a first submarine optical cable that can be any one of the active transmission path and the standby transmission path and a second submarine optical cable that can be another of the active transmission path and the standby transmission path, and
the first submarine terminal station device includes the transmission path monitoring unit.

### Supplementary Note 7

The failure detection apparatus according to supplementary note 6, further including at least one fourth repeater on a second connection between the second submarine terminal station device and the second cable branching device when the second submarine terminal station device does not perform loopback of the supervisory signal, wherein
the fourth repeater passes a main signal and the supervisory signal, and loops back the supervisory signal on the second connection.

### Supplementary Note 8

The failure detection apparatus according to supplementary note 6 or 7, wherein
the first submarine optical cable includes at least one first repeater,
the second submarine optical cable includes at least one second repeater,
the first repeater passes a main signal and the supervisory signal, and loops back the supervisory signal on the first submarine optical cable, and
the second repeater passes a main signal and the supervisory signal, and loops back the supervisory signal on the second submarine optical cable.

### Supplementary Note 9

A cable branching device including
a second switch functional unit that outputs a supervisory signal being split and output to an active transmission path and a standby transmission path, the supervisory signal being output from a test transmission path that is specified one of the active transmission path and the standby transmission path.

### Supplementary Note 10

The cable branching device according to supplementary note 9, wherein
the second switch functional unit outputs an optical wavelength-division multiplexed main signal being output from the active transmission path, to an output destination different from an output destination of the supervisory signal.

### Supplementary Note 11

A failure detection method including
detecting, based on a supervisory signal being split and output to an active transmission path and a standby transmission path and being output from a test transmission path that is specified one of the active transmission path and the standby transmission path, a failure in the test transmission path.

This application is based upon and claims the benefit of priority from Japanese patent application No. 2020-153411, filed on Sep. 14, 2020, the disclosure of which is incorporated herein in its entirety by reference.

### INDUSTRIAL APPLICABILITY

The present invention is able to be used for uses of detecting a failure in an optical transmission system including a submarine optical cable system.

### REFERENCE SIGNS LIST

100, 103, 105, 107 Failure detection apparatus
201, 205 First submarine terminal station device
202 Second submarine terminal station device
500 Transmission path monitoring device
301, 303, 305 First cable branching device
302, 304, 306 Second cable branching device
341 First optical switch
351 Second optical switch
342 Third optical switch
352 Fourth optical switch
371 First wavelength selective switch
381 Second wavelength selective switch
372 Third wavelength selective switch
382 Fourth wavelength selective switch
311 First optical coupler
312 Second optical coupler
401 First repeater
402 Second repeater
403 Third repeater
404 Fourth repeater
321 First filter
322 Third filter
331 Second filter
332 Fourth filter
361 First multiplexer
362 Second multiplexer
610 First submarine optical cable
620 Second submarine optical cable
395 First switch functional unit
396, 398 Second switch functional unit
507 Transmission path monitoring unit

What is claimed is:

1. A failure detection apparatus comprising:
a first optical coupler configured to split and output a supervisory signal to an active transmission path and a standby transmission path;
a second switch functional circuit configured to output the supervisory signal being output from a test transmission path that is specified one of the active transmission path and the standby transmission path; and
a transmission path monitoring circuit configured to detect a failure in the test transmission path, based on the supervisory signal received from the second switch functional circuit.

2. The failure detection apparatus according to claim 1, wherein
a main signal that is optical wavelength-division multiplexed with the supervisory signal is further input to the first optical coupler, and
the second switch functional circuit outputs the main signal being output from the active transmission path, to an output destination different from the transmission path monitoring circuit.

3. The failure detection apparatus according to claim 2, wherein
the first optical coupler and the second switch functional circuit are connected by a first submarine optical cable that can be any one of the active transmission path and the standby transmission path and a second submarine optical cable that can be another of the active transmission path and the standby transmission path, and
the second switch functional circuit includes:
a third filter configured to demultiplex and output, among signals received from the first optical coupler via the first submarine optical cable, the supervisory signal and the main signal;
a fourth filter configured to demultiplex and output, among signals received from the first optical coupler via the second submarine optical cable, the supervisory signal and the main signal;
a third optical switch configured to output, among the main signals being output by the third filter or the fourth filter, the main signal received from the active transmission path;
a fourth optical switch configured to output, among the supervisory signals being output by the third filter or the fourth filter, the supervisory signal received from the test transmission path; and
a second multiplexer configured to multiplex the main signal being output from the third optical switch and the supervisory signal being output from the fourth optical switch, and transmits the multiplexed signal to the transmission path monitoring circuit.

4. The failure detection apparatus according to claim 2, wherein
the first optical coupler and the second switch functional circuit are connected by a first submarine optical cable that can be any one of the active transmission path and the standby transmission path and a second submarine optical cable that can be another of the active transmission path and the standby transmission path, and
the second switch functional circuit includes:
a third wavelength selective switch configured to switch and output, among signals received from the first optical coupler via the first submarine optical cable, the supervisory signal received from the test transmission path and the main signal received from the active transmission path;
a fourth wavelength selective switch configured to switch and output, among signals received from the first optical coupler via the second submarine optical cable, the supervisory signal received from the test transmission path and the main signal received from the active transmission path; and
a second multiplexer configured to multiplex the supervisory signal being output from the third wavelength selective switch or the fourth wavelength selective switch and the main signal being output from the third wavelength selective switch or the fourth wavelength selective switch, and transmits the multiplexed signal to the transmission path monitoring circuit.

5. The failure detection apparatus according to claim 2, further comprising:
a first submarine terminal station device;
a second submarine terminal station device;
a second optical coupler configured to split and output the main signal and the looped-back supervisory signal to the active transmission path and the standby transmission path; and
a first switch functional circuit configured to output the looped-back supervisory signal being output from the test transmission path, to the transmission path monitoring circuit, and output the main signal being output from the active transmission path, to the first submarine terminal station device, wherein
the second switch functional circuit outputs the supervisory signal being output from the test transmission path and the main signal being output from the active transmission path, to the second submarine terminal station device,
the second submarine terminal station device loops back the supervisory signal received from the second switch functional circuit, and
the transmission path monitoring circuit detects a failure in the test transmission path, based on the looped-back supervisory signal received from the first switch functional circuit.

6. The failure detection apparatus according to claim 5, further comprising:
a first cable branching device configured to include the first optical coupler and the first switch functional circuit; and
a second cable branching device configured to include the second optical coupler and the second switch functional circuit, wherein
the first optical coupler and the second switch functional circuit are connected by a first submarine optical cable that can be any one of the active transmission path and the standby transmission path and a second submarine optical cable that can be another of the active transmission path and the standby transmission path, and
the first submarine terminal station device includes the transmission path monitoring circuit.

7. The failure detection apparatus according to claim 6, further comprising at least one fourth repeater on a second connection between the second submarine terminal station device and the second cable branching device when the second submarine terminal station device does not perform loopback of the supervisory signal, wherein
the fourth repeater passes the main signal and the supervisory signal, and loops back the supervisory signal on the second connection.

8. A cable branching device comprising
a second switch functional configured to output a supervisory signal being split and output to an active transmission path and a standby transmission path, the supervisory signal being output from a test transmission path that is specified one of the active transmission path and the standby transmission path.

9. The cable branching device according to claim 8, wherein
the second switch functional circuit outputs an optical wavelength-division multiplexed main signal being output from the active transmission path, to an output destination different from an output destination of the supervisory signal.

10. A failure detection method comprising
detecting, based on a supervisory signal being split and output to an active transmission path and a standby transmission path and being output from a test transmission path that is specified one of the active transmission path and the standby transmission path, a failure in the test transmission path.

11. The failure detection apparatus according to claim 6, wherein
the first submarine optical cable includes at least one first repeater,
the second submarine optical cable includes at least one second repeater,
the first repeater passes a main signal and the supervisory signal, and loops back the supervisory signal on the first submarine optical cable, and
the second repeater passes a main signal and the supervisory signal, and loops back the supervisory signal on the second submarine optical cable.

12. The failure detection apparatus according to claim 7, wherein
the first submarine optical cable includes at least one first repeater,
the second submarine optical cable includes at least one second repeater,
the first repeater passes a main signal and the supervisory signal, and loops back the supervisory signal on the first submarine optical cable, and
the second repeater passes a main signal and the supervisory signal, and loops back the supervisory signal on the second submarine optical cable.
